(19) United States
(12) Patent Application Publication
(10) Pub. No.: US 2024/0339803 A1
(43) Pub. Date: Oct. 10, 2024

(54) FIBER LASER WITH INTRACAVITY FREQUENCY SHIFT AND BANDPASS FILTER

(71) Applicant: Ampliconyx Oy, Tampere (FI)

(72) Inventors: Regina Gumenyuk, Tampere (FI); Xinyang Liu, Tampere (FI)

(21) Appl. No.: 18/579,458

(22) PCT Filed: Jul. 13, 2021
(86) PCT No.: PCT/FI2021/050533

§ 371 Date: Jan. 15, 2024

(51) Int. Cl. H01S 3/1118; H01S 3/067; H01S 3/106

(52) U.S. Cl. CPC H01S 3/1118; H01S 3/067; H01S 3/1068; H01S 2301/085

(57) ABSTRACT

Various example embodiments relate to the field of fiber laser technology. A fiber laser may comprise an active optical fiber configured to amplify an optical signal and a frequency shifter, which may be optically coupled to the active optical fiber. The frequency shifter may be configured to cause a frequency shift to the optical signal in a first direction. The fiber laser may further comprise a bandpass filter, which may be optically coupled to the frequency shifter. The bandpass filter and the active optical fiber may be configured to induce a reverse frequency shift to the optical signal in a second direction opposite to the first direction.

### CROSS-REFERENCE TO RELATED APPLICATIONS

This application is a national phase entry of and claims priority to International Patent Application No. PCT/FI2021/050533 (filed 13 Jul. 2021), the entire disclosure of which is incorporated herein by reference.

### TECHNICAL FIELD

Various example embodiments generally relate to the field of fiber laser technology. Some example embodiments relate to improving stability of fiber lasers employing chirped pulse amplification.

### BACKGROUND

Fiber laser and amplifier technology may be used in various applications. One approach for obtaining high peak power is to use the chirped pulse amplification technique, where the laser pulse is stretched both temporally and spectrally, amplified, and finally compressed to compensate for the stretching. The quality of pulse amplification may depend on the shape of the pulse, characteristics of the chirp, and stability of the fiber laser.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure improve stability of fiber lasers. Further implementation forms are provided in the dependent claims, the description, and the drawings.

According to a first aspect, a fiber laser is provided. The fiber laser may comprise an active optical fiber configured to amplify an optical signal; a frequency shifter optically coupled to the active optical fiber, wherein the frequency shifter is configured to cause a frequency shift to the optical signal in a first direction; and a bandpass filter optically coupled to the frequency shifter, wherein the bandpass filter and the active optical fiber are configured to induce a reverse frequency shift to the optical signal in a second direction opposite to the first direction.

According to an example embodiment of the first aspect, the fiber laser may further comprise: a resonant cavity comprising the active optical fiber, the frequency shifter, and the bandpass filter.

According to an example embodiment of the first aspect, the resonant cavity may further comprise a saturable absorber.

According to an example embodiment of the first aspect, the bandpass filter may have a fixed center frequency.

According to an example embodiment of the first aspect, the active optical fiber may be configured to provide a maximum gain substantially at the fixed center frequency of the bandpass filter.

According to an example embodiment of the first aspect, the frequency shift in the first direction may be 10-1000 MHz.

According to an example embodiment of the first aspect, the frequency shift in the first direction may be approximately 80 MHz.

According to an example embodiment of the first aspect, a width of the bandpass filter may be 2-5 nm.

According to an example embodiment of the first aspect, the bandpass filter may have a substantially Gaussian or super Gaussian frequency response.

According to an example embodiment of the first aspect, the optical signal may comprise a similariton pulse.

According to an example embodiment of the first aspect, the fiber laser may be configured for chirped pulse amplification of the optical signal.

According to a second aspect, a method is provided. The method may comprise amplifying an optical signal by an active optical fiber; frequency shifting the optical signal in a first direction; and inducing, by a bandpass filter and the active optical fiber, a reverse frequency shift to the optical signal in a second direction opposite to the first direction.

According to an example embodiment of the second aspect, the resonant cavity may comprise the active optical fiber, the frequency shifter, and the bandpass filter

According to an example embodiment of the second aspect, the resonant cavity may further comprise a saturable absorber.

According to an example embodiment of the second aspect, the bandpass filter may have a fixed center frequency.

According to an example embodiment of the second aspect, the active optical fiber may be configured to provide a maximum gain substantially at the fixed center frequency of the bandpass filter.

According to an example embodiment of the second aspect, the frequency shift in the first direction may be 10-1000 MHz.

According to an example embodiment of the second aspect, the frequency shift in the first direction may be approximately 80 MHz.

According to an example embodiment of the second aspect, a width of the bandpass filter may be 2-5 nm.

According to an example embodiment of the second aspect, the bandpass filter may have a substantially Gaussian or super Gaussian frequency response.

According to an example embodiment of the second aspect, the optical signal may comprise a similariton pulse.

According to an example embodiment of the second aspect, the method may further comprise performing chirped pulse amplification of the optical signal by the fiber laser.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments.

In the drawings:

FIG. 1 illustrates an example of a fiber laser, according to an example embodiment.

FIG. 2 illustrates an example of frequency shifting when a spectral width of a pulse is narrower than a spectral width of a bandpass filter, according to an example embodiment;

FIG. 3 illustrates an example of frequency shifting when a spectral width of a pulse is wider than a spectral width of a bandpass filter, according to an example embodiment; and

FIG. 4 illustrates an example of a method for amplifying an optical signal in a fiber laser, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Amplification of short pulses of optical signals by the chirped pulse amplification technique enables to obtain high peak power, which is generally desired in fiber laser systems. The quality of such pulse amplification, and its compressibility down to transform-limited value without sidelobes, may be however dependent on its shape and chirp. In chirped pulse amplification, the pulses coming out from the cavity of the fiber laser may be chirped, that is, have a temporally varying wavelength, for example increasing wavelength. Furthermore, the pulses may be long, for example in the order of a few picoseconds (ps) or tens of picoseconds. This may be due to accumulated dispersion occurring while the optical signal propagates in the cavity.

However, externally the pulses may be compressed down to a so-called transform limited value, for example using optical elements that introduce dispersion of opposite sign. This value may be determined by the spectral width, which may be almost reciprocal of full-width at half maximum of the optical spectrum. Transform-limited values may be for example below a few hundreds of femtoseconds. Besides the dispersion, pulses may also accumulate nonlinearity and it may not be possible to compensate for this with optical elements. As a result, the compressed pulse may contain a main peak and sidelobes (e.g. small sides peaks). The latter may be considered as unwanted signal components since they drain power from the main peak. With further amplification of such pulses the situation may become even worse and the sidelobes may be more preannounce, meaning that they contain more power. Furthermore, similar effect may occur after amplification. This is a reason why amplification in ultra-short pulse laser systems may be demanding.

Among different pulses generable by fiber lasers are parabolic shaped pulses (similaritons), which may have suitable characteristics for amplification. Similaritons may tolerate high nonlinear phase and consequently possess the property of being substantially free of wave-breaking. During propagation in the optical fiber with normal dispersion constituted fiber-based amplifier stages, the similariton pulse may substantially maintain its parabolic shape and a linear chirp, while both spectral and temporal widths may be exponentially broadened with distance, potentially endowing the similariton ability to have wide spectral bandwidth, and consequently, a short pulse duration may be obtained. This feature allows pulse compression down to transform-limited value without sidelobes, and the power may be concentrated within a single short pulse.

However, similariton pulses may be highly unstable and therefore stabilization may be applied within the cavity, for example by means of intracavity spectrum broadening compensation and suppression of low-intensity instabilities. Otherwise instability within the cavity could cause the pulses to be destroyed and only continuous wave (narrow band) signals being left in the cavity. Therefore, to restore the pulse operation, it may be necessary to manually adjust the laser parameters, for example by rotating or moving the optical components or by changing the pump power.

The problem of intracavity spectrum broadening compensation may be successfully solved in both all-normal cavities and cavities with a dispersion map. However, the problem of environmental stability of the laser cavity remains actual. Example embodiments of the present disclosure therefore enable to improve environmental stability of fiber lasers. For example, improved stability may be achieved for similariton pulses, which are generally sensitive to any perturbations, such for example air currents and even small temperature changes (e.g. less than one degree). The example embodiments described herein enable obtaining much less sensitivity to external or even internal perturbations, for example intracavity continuous wave signals).

Low-intensity instabilities may be suppressed by a saturable absorber arranged in the cavity. The complexity of finding solution to the latter problem is however affected by the fact that the similariton regime in the cavity may require ultra-fast saturable absorption. One solution for similariton lasers is nonlinear polarization rotation (NPR), which may be used to suppress instabilities by introducing nonlinear losses. Short pulses from a fiber laser may be obtained for example from a cavity with self-consistent similariton evolution employing NPR mode-locking. NPR may be however subject to environmental perturbations and may require periodic manual adjustment to maintain the laser in operation. Moreover, the sensitivity to external perturbations in an all-normal fiber laser, operated below 1300 nm, may be higher than for cavities with dispersion compensation due to spectrum broadening compensation mechanisms. Therefore, the NPR technique alone may not be suitable for hands-free operation in all-normal dispersion fiber lasers and therefore application of NPR in industrial lasers may be difficult. As a consequence, it may be challenging to use similariton pulses for amplification in commercial high peak power systems.

Fiber-based ultrashort pulse lasers may be considered as an enabler for many laser-based applications due to high stability, low maintenance cost, and high beam quality. Such systems may be however highly complicated and comprise many stages of fiber-based amplifiers. Despite the advantages of the fiber technology, it comes with the drawback of nonlinear effects, for example self-phase modulation that introduces a nonlinear phase. During amplification this effect may negatively affect quality and compressibility of the pulse. Additional pulse shape correction may be used to overcome this problem. This may however limit the system performance and require incorporation of additional elements. Another solution would be to use similariton pulses. Having a parabolic shape with linear chirp, the similariton pulses may be suitable for amplification in fiber laser systems. For example, similariton pulses may be characterized by having no limits to nonlinear phase accumulation without wave breaking. This enables power scalability with excellent pulse quality and preserving substantially all the power in a single pulse. Implementation of a reliable solution for fiber-based laser seed generated similaritons would enable to develop a new class of laser systems with amplified similariton pulses, resulting in improved pulse quality and higher power.

According to an example embodiment, a fiber laser may comprise an active optical fiber configured to amplify an optical signal and a frequency shifter, which may be optically coupled to the active optical fiber.

The frequency shifter may be configured to cause a frequency shift to the optical signal in a first direction. The fiber laser may further comprise a bandpass filter, which may be optically coupled to the frequency shifter. The bandpass filter and the active optical fiber may be configured to induce a reverse frequency shift to the optical signal in a second direction opposite to the first direction.

The reverse frequency shift may be induced by the combination of the active optical fiber and the bandpass filter. Non-linearities of the amplification at the fiber cause spectral broadening for pulsed signals. However, continuous wave signals may not experience spectral broadening since their peak power may be lower. In general, the spectral broadening may be smaller for narrowband signals. As the amplification continues to be strong at the center frequency of the bandpass filter, the spectral content of the optical signal is shifted back towards the center of the filter, thereby causing the reverse shift. The frequency shifter, bandpass filter and the active optical fiber may be therefore configured to filter out narrowband signals (e.g. CW) and pass broadband signal, such as for example pulsed optical signal described herein.

Even though some example embodiments have been describe using the similariton pulses as an example, it is appreciated that the example embodiments may be applied to other type of pulses as well. However, the example embodiments may be advantageously applied to similariton pulses, for which other techniques may not provide sufficient pulse quality.

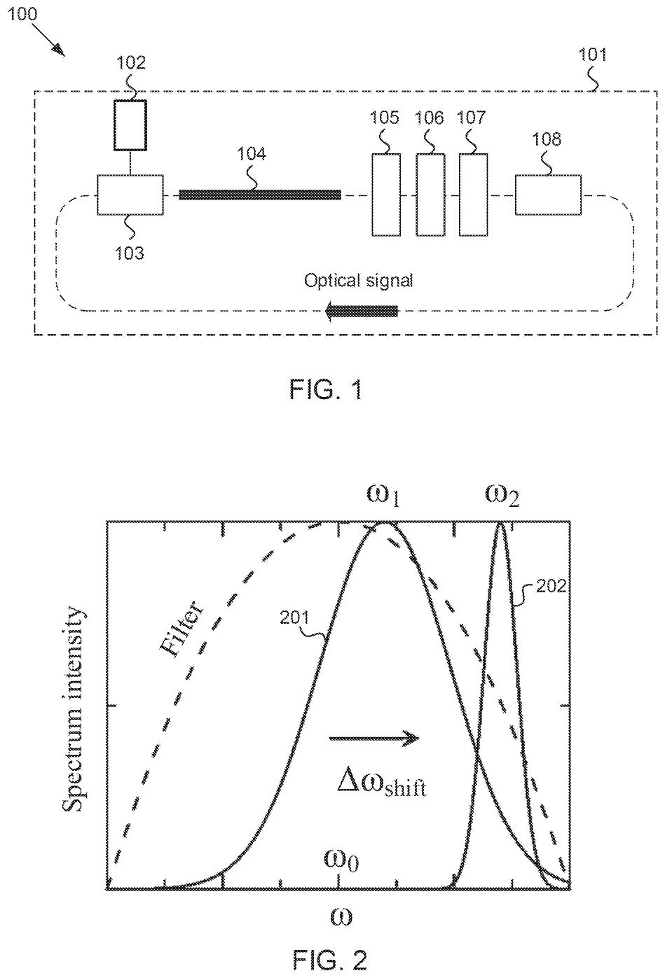

FIG. 1 illustrates an example of a fiber laser, according to an example embodiment. The fiber laser 100 may be used for example for generation of chirped similariton pulses. The fiber laser 100 may comprise a resonant cavity 101. The resonant cavity 101 may be for example formed, optionally along with other components, by two reflecting mirrors, one of the mirrors being partially transparent to allow laser light to escape from the cavity. However, the example embodiments may be alternatively applied to other type of cavity designs, instead of a linear cavity terminated by two mirrors.

The resonant cavity 101 may for example comprise a figure-eight cavity, a figure-nine cavity, a ring cavity, or the like. The resonant cavity 101 may comprise, or in general be pumped by, a source of pump radiation 102. The resonant cavity may further comprise components (elements) 103 to 108. Some of the components may be however optional.

The resonant cavity 101 may comprise an active optical fiber 104, for example a rare-earth doped single-mode active optical fiber. For example, the core of the active optical fiber 104 may be doped with at least one rare-earth element. The active optical fiber 104 may be therefore configured to amplify an optical signal. Rare-earth elements comprises a group of materials including cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y).

The core of the active optical fiber 104 may be doped with one or more of these elements, for example with Er or Yb, or a combination of Er and Yb. During operation the rare-earth ions of the active optical fiber 104 may absorb pump radiation provided by the pump radiation source 102. The pump radiation may be coupled to the active optical fiber 104 by an input fiber coupler 103. Amplification within the active optical fiber 104 may be enabled by stimulated emission. Different rare-earth elements may be used for different wavelengths.

For example, Yb may be used for 980-1100 nm wavelength range and Er may be used for 1535-1600 nm wavelength range.

The active optical fiber 104 may be configured to support single-mode operation. A single-mode fiber may be configured to carry a single mode of light, which may be understood as a single ray of light propagating through the core of the active optical fiber 104. Single-mode fibers may have a relatively thin core. For example, the single mode regime of propagation may be enabled for a step index fiber when so called normalized frequency V<2.405, where

$$V = \frac{2 π}{λ} r N A = \frac{2 π}{λ} r \sqrt{{n}_{c o r e}^{2} - {n}_{cladding}^{2}} ,$$

where λ is the wavelength, r is the radius of the core, NA is the numerical aperture of the core, and where n_{core} and n_{cladding} are the refractive indices of the core and a cladding layer surrounding the core, respectively.

The resonant cavity 101 may further comprise a saturable absorber 105, which may be a passive saturable absorber. The saturable absorber 105 may be configured to provide a saturable absorption effect to incident light. The saturable absorber 105 may be optically coupled to the output of the active optical fiber 104. The (passive) saturable absorber 105 may be an optical component, which may operate based on nonlinear material absorption of incident light. Examples of the saturable absorber include semiconductor saturable absorber mirrors (SESAM), carbon nanotubes (CNT), or the like. The saturable absorber 105 may be also configured to provide a nonlinear mechanism of incident light absorption, for example by means of artificial saturable absorption such as nonlinear polarization rotation, phase shift, or the like.

The resonant cavity 101 may further comprise a frequency shifter 106, The frequency shifter 106 may be optically coupled to the saturable absorber 105, or to the active optical fiber 104 if the saturable absorber 105 is not present. The frequency shifter 106 may therefore optically coupled to the active optical fiber 104, either directly or indirectly, for example via the saturable absorber 105, in order to receive the optical signal from the active optical fiber 104.

The frequency shifter 106 may comprise for example an acousto-optic frequency shifter that operates based on the acousto-optic effect. When a voltage is applied to glass of the acousto-optic frequency shifter, the voltage may induce acoustic grating inside the glass. The light propagating through the grating undergoes diffraction, however, at the same time the center frequency is shifted by a small amount, for example in the order of tens of MHz.

The resonant cavity 101 may further comprise a bandpass filter 107. The bandpass filter 107 may be an optical component, which may be embodied as a separate component (e.g. fiber pigtailed) or integrated with any other elements of the resonant cavity 101. The bandpass filter 107 may for example comprise a series of layers of dielectric material deposited on a substrate, for example glass. The layers of dielectric material may induce the selective transmission of desired wavelength or a wavelength range. The layers may differ from each other by their refractive indexes. For example, the bandpass filter 107 may comprise a sandwich structure, where a layer of low refractive index material is followed by other layer(s) of high-refractive index material. The layers may be however separated by a spacer. The thickness of each dielectric layer may be approximately λ/4, where λ is the central wavelength of the bandpass filter. The center wavelength may also correspond to the highest transmittance through the bandpass filter 107. The spacer layers may be placed between the dielectric stacks and have a thickness of (nλ)/2, where n is an integer. The spacer layers may comprise colored glass, epoxy, dyes, metallic, or dielectric layers. A Fabry-Perot cavity may be formed by each spacer layer sandwiched between the dielectric layers. The bandpass filter 107 may be mounted on an engraved metal ring. This improves protection and ease of handling. The sandwich-type structure described above may be fabricated on a surface of frequency shifter glass. The bandpass filter 107 may be therefore integrated with the frequency shifter 106. Alternatively, the sandwich-type structure may be fabricated on a separate glass substrate, which may be inserted in any components of the cavity, for example the fiber coupler(s) 103, 108, or have its own package with fiber input and output. In general, any suitable type of bandpass filter may be used.

The resonant cavity 101 may further comprise an output fiber coupler 108, which may be configured to couple a portion of the light out of the resonant cavity 101. The fiber components described above may comprise or be composed of non-polarization-maintaining or polarization-maintaining single-mode fibers.

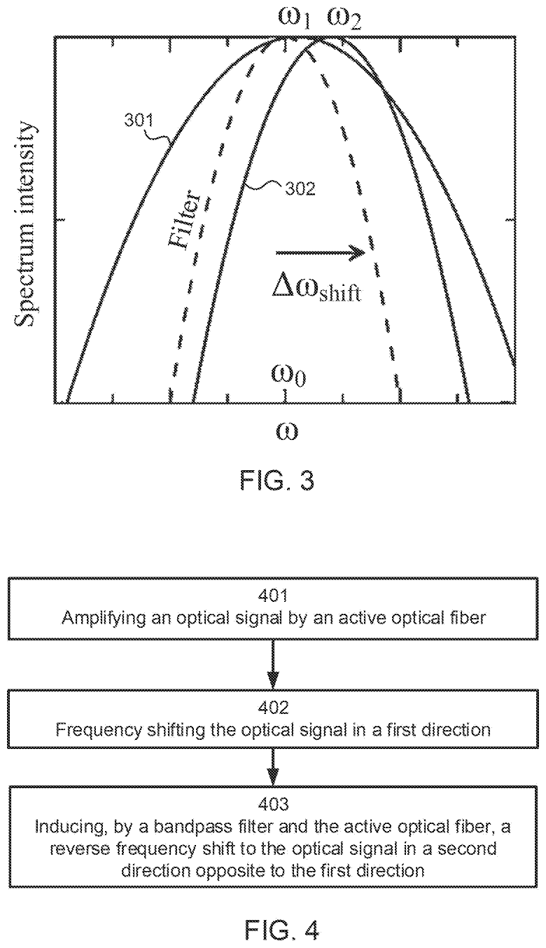

The fiber laser 100 of FIG. 1 enables stabilization of a similariton laser using the frequency shifter 106 that employs a frequency shift to stabilize the laser operation. A stabilized similariton laser may therefore comprise: a fiber-coupled pump source configured to emit light, an input fiber coupler for coupling the pump energy from the fiber coupled pump source to a resonant cavity. The pump energy may be absorbed by a rare-earth doped single-mode optical fiber to achieve population inversion. The stabilized similariton laser may further comprise a passive saturable absorber configured to provide saturable absorption effect to incident light, a frequency shifter, a narrow bandpass filter, and an output coupler to couple some light out from the resonant cavity. The frequency shifter may continuously apply a frequency shift onto incident light. The incident light may be therefore continuously shifted towards one edge of the narrow bandpass filter in the frequency domain and losses may be introduced on light components near the edge of narrow bandpass filter. Light pulses with high peak power may compensate the loss by nonlinearity when propagating in the fiber, while continuous-wave light cannot induce enough nonlinearity to compensate the loss and will consequently die out. Through this mechanism, continuous-wave light components will be suppressed. Operation of the fiber laser 100 will be further described below with reference to FIG. 2 and FIG. 3.

FIG. 2 illustrates an example of frequency shifting when a spectral width of a pulse is narrower than a spectral width of a bandpass filter, according to an example embodiment. The principle of frequency shifting operation is illustrated for a mode-locked fiber laser having an intracavity bandpass filter. FIG. 2 illustrates the frequency shifted feedback (FSF) mode-locking scheme for the pulsed regime characteristic to conservative, dispersion-managed solitons (DM), and dissipative solitons formed in ANDi laser. In case of dispersion-managed solitons the cavity may comprise components with negative and positive dispersion values.

Curve 201 illustrates a spectrum of an optical signal (light) arriving at the band pass filter 107. The optical signal may comprise a pulse, for example a similariton pulse. The center frequency of the pulse spectrum is initially at ω₁. The frequency response of the bandpass filter, centered at frequency ω₀, is illustrated with the dashed line. The frequency response of the bandpass filter may have a substantially Gaussian shape or super Gaussian shape. A smooth slope of such filter is beneficial for spectral shaping of the optical signal. Using a filter with such frequency response enables to avoid abrupt spectral shapes, which may negatively affect operation of the laser. The center frequency of the bandpass filter 107 may be fixed, for example time-invariant and independent of the frequency of the incoming pulse, in contrast to filters whose center frequency sweeps over a frequency range. In this example, the spectrum of the incoming pulse is narrower than the width of the bandpass filter 107.

Curve 202 illustrates the pulse spectrum, having center frequency ω₂, which has been cut by the bandpass filter 107 and shifted by the frequency shifter 106. A frequency shift Δω_{shift}=ω₂−ω₁ is introduced by the frequency shifter 106. The amount of the frequency shift may be generally in the megahertz range, for example 10-1000 MHz. In one embodiment, the frequency shift is approximately 80 MHz. The width of the bandpass filter may be 2-5 nm (in wavelength). These parameters provide an example of a configuration suitable for suppressing narrowband signals in industrial fiber lasers. In general, the frequency shifter 106 may be configured to cause a frequency shift to an optical signal received from the active optical fiber 104 in a first direction (either up or down).

The bandpass filter 107 and the active optical fiber 104 may be together configured to induce a reverse frequency shift to the optical signal. The reverse frequency shift may occur in a second direction, which is opposite to the first direction (the direction of the frequency shift by the frequency shifter 106). For example, if the frequency shifter 106 is configured to shift the pulse spectrum up, the reverse shift may occur downwards, and vice versa. The bandpass filter 107 may be considered to induce the reverse frequency shift in combination with the amplification at the active optical fiber 104. The active optical fiber 104 may be configured to provide maximum gain substantially at the center frequency of the bandpass filter 107. The maximum amplification may therefore occur when the center frequency of the bandpass filter 107 coincides with the center of the pulse spectrum.

The frequency shifter 107 moves the center frequency of the pulse spectrum towards the edge of the bandpass filter 107 (up or down). This works the same way for both narrow (e.g. CW) and broad (pulse signal) spectra. When the spectrum is broad, the bandpass filter 107 additionally cuts it's part and the spectral width after the bandpass filter is equal to the width of the bandpass filter 107. The resulting spectrum experiences broadening during the amplification stage in the active optical fiber 104.

Considering the upward frequency shift direction, as illustrated in FIG. 3, this spectral amplification is however more efficient at the left part of the spectrum than at the right part of the spectrum, because the maximum gain is at the central part of the bandpass filter 107. Therefore, the spectrum central wavelength is shifted back, which causes the reverse shift.

The peak power of the pulsed signal is higher than the peak power of the CW signal, since the pulsed signal has more diverse frequency content. Therefore, self-phase modulation causes spectral broadening of the pulse signal, while the CW signal spectrum remains unchanged, being continuously shifted away from the filter passband and therefore experiencing high losses every round trip. As a result, the CW signal will die out.

The frequency shifter 106, having the function in the resonant cavity 101 to continuously introduce the small frequency shift up or down, is therefore able to discriminate strong pulse and low-intensity continuous wave (CW) radiation in the frequency domain with the help of the bandpass filter 107 (spectral filter).

Realization of any mode-locking technique may be possible only in a cavity with positive feedback, which means that greater intensities may undergo lower losses. In the case of NPR mode-locking, the selection of the orientation of controllers and polarizers may lead to a situation where the transmission of the resonator increases with an increase in the peak power of the pulse or pulse narrowing resulting in effective separation of the pulsed signal from the CW signal. In the case of FSF mode-locking, positive feedback may be formed when the generated pulse passes through the frequency shifter 106 and subsequent filtering by the bandpass filter 107 (FIG. 2). Under the influence of the frequency shift, the pulse spectrum is displaced from the center of the bandpass filter 107. However, as noted above, the bandpass filter 107 induces a reverse shift. The amount of the reverse frequency shift may be proportional to the slope of the bandpass filter 107 at the pulse spectrum frequency (ω₂) after the frequency shift and to the square of the pulse spectrum width. With a balance of these forces, a situation arises that corresponds to positive feedback. A pulse with a wide spectrum experiences less losses, because its carrier frequency is closer to the center of the bandpass filter 107 than the carrier frequency of a narrowband pulse. So, the continuum (noise) and narrowband pulses are filtered, and their energy is transferred to the broadband pulse. This is a very efficient process leading to formation of highly environmentally stable pulsed regime in the resonant cavity 101.

FIG. 3 illustrates an example of frequency shifting when a spectral width of a pulse is wider than spectral width of a bandpass filter, according to an example embodiment. The principle of frequency shifting operation is illustrated for a mode-locked fiber laser having an intracavity bandpass filter. FIG. 3 illustrates the FSF-mode-locking scheme with similariton amplifier laser.

In the case of a similariton laser, parameters of the pulse may undergo a significant change during its evolution. As a result, the bandpass filter 107 may receive pulses with a spectral width (cf. curve 301) exceeding the width of the bandpass filter 107 (dashed line) several times, for example more than five times. Curve 302 illustrates again the pulse spectrum after the frequency shifter 106 and the bandpass filter 107. In this case, the reverse shift induced by the bandpass filter 107 may increase significantly, and the differences in transmission between pulses of different intensities may decrease. It is however noted that despite an increase of the reverse shift for broadband pulses, the positive feedback continues to be strong and effective for narrowband pulses or low-intensity CW propagated in the same cavity.

It is further noted that either NPR or FSF techniques alone may not provide a reliable similariton regime. The required parameters for regime establishment may be either non-realistic (FSF) or very limited (NPR). Therefore, any external perturbation may cause regime destabilization. Exploiting the disclosed hybrid mode-locking for similariton-type lasers brings an additional pulse stabilization mechanism to the resonant cavity 101 by means of efficient filtering of low-intensity instabilities and narrowband (e.g. CW) signals. Also, the range of laser parameters, in which mode-locked operation is possible, is enlarged. Therefore, the system is more robust to the external perturbations.

Hence, the example embodiments disclosed herein provide the benefits of higher performance of laser-based systems by means of improved amplification efficiency, power scalability, and nearly perfect pulse quality. Similariton pulses may provide a desired solution for fiber laser systems. The example embodiments of the present disclosure improve similariton seed reliability and thereby enable industrial application of similariton based solutions in commercial devices.

FIG. 4 illustrates an example of a method for amplifying an optical signal in a fiber laser, according to an example embodiment.

At 401, the method may comprise amplifying an optical signal by an active optical fiber.

At 402, the method may comprise frequency shifting the optical signal in a first direction.

At 403, the method may comprise inducing, by a bandpass filter and the active optical fiber, a reverse frequency shift to the optical signal in a second direction opposite to the first direction.

Further features of the method directly result for example from the functionalities and parameters of the fiber laser 100 or one or more components thereof, as described in the appended claims and throughout the specification, and are therefore not repeated here. Different variations of the methods may be also applied, as described in connection with the various example embodiments. Any range or value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The term ‘comprising’ is used herein to mean including the blocks or elements identified, but that such blocks or elements do not comprise an exclusive list. An apparatus according to any example embodiment may therefore contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A fiber laser, comprising:
an active optical fiber configured to amplify an optical signal;
a frequency shifter optically coupled to the active optical fiber, wherein the frequency shifter is configured to cause a frequency shift to the optical signal in a first direction; and
a bandpass filter optically coupled to the frequency shifter, wherein the bandpass filter and the active optical fiber are configured to induce a reverse frequency shift to the optical signal in a second direction opposite to the first direction.

2. The fiber laser according to claim 1, further comprising:
a resonant cavity comprising the active optical fiber, the frequency shifter, and the bandpass filter.

3. The fiber laser according to claim 2, wherein the resonant cavity further comprises a saturable absorber.

4. The fiber laser according to claim 1, wherein the bandpass filter has a fixed center frequency.

5. The fiber laser according to claim 4, wherein the active optical fiber is configured to provide a maximum gain substantially at the fixed center frequency of the bandpass filter.

6. The fiber laser according to claim 1, wherein the frequency shift in the first direction is 10-1000 MHz.

7. The fiber laser according to claim 1, wherein the frequency shift in the first direction is approximately 80 MHz.

8. The fiber laser according to claim 1, wherein a width of the bandpass filter is 2-5 nm.

9. The fiber laser according to claim 1, wherein the bandpass filter has a substantially Gaussian or super Gaussian frequency response.

10. The fiber laser according to claim 1, wherein the optical signal comprises a similariton pulse.

11. The fiber laser according to claim 1, wherein the fiber laser is configured for chirped pulse amplification of the optical signal.

12. A method comprising:
amplifying an optical signal by an active optical fiber;
frequency shifting the optical signal in a first direction; and
inducing, by a bandpass filter and the active optical fiber, a reverse frequency shift to the optical signal in a second direction opposite to the first direction.

13. The method according to claim 12, wherein the resonant cavity comprises the active optical fiber, the frequency shifter, and the bandpass filter.

14. The method according to claim 13, wherein the resonant cavity further comprises a saturable absorber.

15. The method according to claim 14, wherein the bandpass filter has a fixed center frequency.

16. The method according to claim 15, wherein the active optical fiber is configured to provide a maximum gain substantially at the fixed center frequency of the bandpass filter.

17. The method according to claim 12, wherein the frequency shift in the first direction is 10-1000 MHz.

18. The method according to claim 12, wherein the frequency shift in the first direction is approximately 80 MHz.

19. The method according to claim 12, wherein a width of the bandpass filter is 2-5 nm.

20. The method according to claim 12, wherein the bandpass filter has a substantially Gaussian or super Gaussian frequency response.

21. The method according to claim 12, wherein the optical signal comprises a similariton pulse.

22. The method according to claim 12, wherein the active optical fiber is configured for chirped pulse amplification of the optical signal.
